(19) United States
(12) Patent Application Publication
(10) Pub. No.: US 2023/0242049 A1
(43) Pub. Date: Aug. 3, 2023

(54) DECORATIVE AUTOMOTIVE COMPONENT HAVING MULTIPLE ELECTRICAL CURRENT PATHWAYS AND DIFFERENT SURFACE FINISHES

(71) Applicant: Lacks Enterprises, Inc., Grand Rapids, MI (US)

(72) Inventors: Michael Lavallee, Grand Rapids, MI (US); Garry Van Houten, Middleville, MI (US)

(21) Appl. No.: 18/190,205

(22) Filed: Mar. 27, 2023

Related U.S. Application Data
(63) Continuation-in-part of application No. 17/170,241, filed on Feb. 8, 2021.
Application No. 17/170,241 is a continuation-in-part of application No. 16/679,635, filed on Nov. 11, 2019, now Pat. No. 11,639,552.
Application No. 16/679,635 is a continuation-in-part of application No. 14/712,702, filed on May 14, 2015, now Pat. No. 11,408,086.
(63) Continuation-in-part of application No. 14/712,665, filed on May 14, 2015, now abandoned.
(60) Provisional application No. 62/971,628, filed on Feb. 7, 2020.

(51) Int. Cl. B60R 13/02

(52) U.S. Cl. CPC B60R 13/02; B60R 2013/0281; B60R 2013/0287

(57) ABSTRACT

A decorative work piece or component, such as a decorative automotive trim component, and method for plating a work piece is provided. An electroless layer of material is applied to the work piece using an electroless plating process. A barrier in electrical conductivity is provided on the work piece to divide the work piece into a first segment and a second segment which are substantially electrically insulated from one another, prior to electroplating the work piece. A plurality of methods are disclosed for dividing the work piece into the first and second segments. The component includes different surface finishes on each of the electrically isolated segments, with the finishes having different appearance, gloss level, color, and/or distinction of image as a result of electroplating and without post-electroplating mechanical alteration and assembly.

### CROSS-REFERENCE TO RELATED APPLICATIONS

This application is a continuation-in-part of co-pending U.S. Pat. No. 17/170,241, filed Feb. 8, 2021, titled “Method for Creating Multiple Electrical Current Pathways on a Work Piece Using Laser Ablation,” which claims the benefit of U.S. Provisional Pat. Application No. 62/971,628, filed Feb. 7, 2020, and is a continuation-in-part of U.S. Pat. Application No. 16/679,635, filed Nov. 11, 2019, titled “Method for Creating Multiple Electrical Current Pathways on a Work Piece,” which is a continuation-in-part of U.S. Pat. Application No. 14/712,702, filed May 14, 2015, titled “Method for Creating Multiple Electrical Current Pathways on a Work Piece,” now U.S. Pat. No. 11,408,086, issued Aug. 9, 2022, the entire content of all of which are hereby incorporated by reference in their entirety. This application is also a continuation-in-part of co-pending U.S. Pat. Application No. 14/712,665, filed May 14, 2015, titled “Work Piece Having Electrical Current Pathways,” the entire content of which is hereby incorporated by reference in its entirety.

### TECHNICAL FIELD

The present disclosure relates generally to improved aesthetics for work pieces, including decorative automotive work pieces or components, by a method of electroplating a decorative automotive work piece or component. More specifically, the present disclosure relates to a method for creating multiple electrical current pathways on a work piece to allow for the presence of multiple separate finishes on a single plastic work piece to create the decorative automotive work piece or component.

### BACKGROUND OF THE DISCLOSURE

Plated decorative chrome finishes have long been available for various products in the automotive, appliance, consumer electronics, and household application industries. Variations in the deposition methods, processing conditions, and solution makeup of the various types of metals have subsequently resulted in aesthetic variations in the final product. These variations in processing, chemical, and deposition techniques are able to generate different color metal finishes, lower gloss levels, and less distinction of image (DOI) in the metal finish of work pieces all with an eye to improving aesthetics. Examples of these finishes include but are not limited to Bright Chrome, Black Nickel, Black Chrome, and the like. Another exemplary finish that has been employed is Satin Chrome, which involves varying the reflectivity of the underlying metal layer such as by creating more pits in the substrate surface. Varying the degree of reflectivity allows for many different types of metal finishes. Often, these variations are combined with a bright chromium finish in assemblies to 1) complement each other and 2) bring more aesthetic appeal to the final product.

A known method of finishing work pieces to provide a final product that has multiple distinct surface finishes includes utilizing work piece assemblies that are made up of multiple components, each having a different metal finish and which are assembled to form the final product. This practice, while effective, results in multiple operations and multiple sets of tooling which adds significant cost to the final product.

Another known method of finishing work pieces to provide a final product that has multiple distinct surface finishes includes applying bright and satin-like finishing to the surface of the work piece with masking and pre or post surface treatments using abrasive grains such as iron powder, glass powder, silicon oxide, alumina and the like. Molded in texture or surface effects have also been employed to create variation in the metal finish of the work piece by selectively incorporating the texture or surface finish into a portion of the work piece prior to application of a metal finish. However, when such work pieces, which include one section employing these surface effects and another part without these effects, are both subjected to electroplating, the leveling characteristic of the electroplated layer on these two sections does not create the visual effect of two distinct metal surface finishes as desired. Also, the pre and post surface treatments are costly and require an additional operation.

Vacuum metallization and chemical vapor deposition techniques are able to achieve a final product that has segments with different finishes, but are very costly and limited from a performance standpoint in many environments because of the thin layer of metal that results from these techniques. Additionally, physical vapor deposition coatings must include an organic coating thereover to protect the deposited metal layer. This additional step increases labor costs and creates an “orange peel” look due to the fact that the organic coating is not completely smooth.

Another method of creating two distinct surface effects on a work piece includes masking and painting using tinted basecoats and clear coats. Although this method creates the desired effect, it disadvantageously requires an additional painting operation which adds cost to the final product.

In view of the above, there remains a need for improved decorative work pieces and methods of treating work pieces that provide for a final product that includes more than one surface finish on a single work piece. More specifically, there remains a need for a method which offers more degrees of flexibility to designers and manufacturers with regards to its aesthetic effects while reducing the overall part and manufacturing costs by eliminating secondary operations.

### SUMMARY OF THE DISCLOSURE

A decorative work piece is provided. The decorative work piece has a plastic substrate with a front surface and a back surface and a first barrier to electrical conductivity located on at least the front surface to divide the front surface into a first segment and a second segment. A first decorative layer is disposed on the first segment and a second decorative layer is disposed on the second segment. The first decorative layer is different than the second decorative layer such that the first segment has a different appearance than the second segment.

The decorative work piece may further include a base metal layer disposed on the first segment and the second segment, the barrier being substantially free of the base metal layer.

The decorative work piece having the first and second electrically isolated segments having different appearance may be created according one or more of the methods and processes described herein, and may include resulting structure exclusive to such methods and processes.

A method for plating a plastic work piece using a power source having a positive terminal and a negative terminal is provided. The method includes applying an electroless layer of material to the work piece using an electroless plating process. The positive terminal of the power source may be connected to a first anode and the negative terminal of the power source may be connected to the work piece. The work piece can then be immersed in a first aqueous solution that contains the first anode. The first anode may then be positively charged and the work piece may be negatively charged to cause metal ions in the first aqueous solution to be passed onto the electroless layer of the work piece.

The method can further include creating at least one barrier in electrical conductivity in the work piece prior to the step of immersing the work piece in a first aqueous solution to divide the work piece into at least a first segment and a second segment which are substantially electrically insulated from one another.

The negative terminal of the power source can also be connected to the second segment of the work piece. The method may also include immersing the work piece in a second aqueous solution that contains a second anode. Once the work piece is immersed in the second aqueous solution, the second anode can be positively charged and a second negative charge may be applied to the second segment of the work piece to cause metal ions from the second aqueous solution to be passed onto the electroless layer of only the second section of the work piece to form a second electroplated layer on the second segment of the work piece.

It is therefore an aspect of the present disclosure to provide a decorative work piece and a method for plating a work piece with multiple surface finishes. The method eliminates the need for costly secondary operations to finish the work piece since creating the barrier in electrical conductivity and respectively electroplating the first and second segments of the work piece may be done in an inexpensive and simple process. In one aspect, a method of creating a part having multiple decorative surfaces is provided, comprising: forming a plastic work piece of a first material; creating at least one barrier in electrical conductivity in the work piece to divide the work piece into multiple electrically isolated segments including a first segment and a second segment; connecting a first segment of the work piece to a first circuit including a first power source; connecting a second segment of the work piece to a second circuit including a second power source; creating a first metal surface of the work piece on the first segment via a plating process; creating a second metal surface of the work piece on the second segment via a plating process; wherein the first and second metal surfaces of the work piece have different surface finishes; wherein the first and metal surfaces are created from the same base metal and a common solution.

In one aspect, the first metal surface includes multiple layers and the second metal surface includes multiple layers.

In another aspect, a method of creating a part having multiple decorative surfaces is provided, comprising: forming a plastic work piece; rendering a first segment and a second segment of the work piece conductive, wherein the first and second segments are electrically isolated relative to each other; creating a first metal surface on the first segment of the plastic work piece through a plating process that includes applying a first current via a first circuit that includes the first segment; creating a second metal surface on the second segment of the plastic work piece through a plating process that includes applying a second current via a second circuit that includes the second segment; wherein the first metal surface the second metal surface have the same base metal; wherein the first and second current are applied simultaneously to create at least one layer of the first and second metal surfaces simultaneously. The method additionally includes applying only the first current to form one or more additional metal layers on the first segment. The method can further include subsequently applying only the second current to form one or more additional metal layers on the second segment.

In one aspect, the first circuit includes a first power source and the second circuit includes a second power source.

In one aspect, the first metal surface is Bright Chrome and the second metal surface is different whereby the work piece has multiple different surface appearances.

In one aspect, the at least one barrier is formed of a material that substantially prevents an electroless layer of material being formed thereon, and the step of rendering the first and second segments conductive includes applying an electroless layer of material on the first segment and the second segment.

In one aspect, the at least one barrier is defined by an absence of the electroless layer of material.

In one aspect, a decorative automotive trim component is provided, comprising: a molded component having a molded base substrate with a first barrier to electrical conductivity disposed therealong, wherein the molded component has a front surface and a back surface opposing the front surface; the base substrate being formed of a plastic metal plateable material, wherein the base substrate and the first barrier to electrical conductivity combine to define the overall shape of the molded component, upon which multiple stacked layers are applied to different segments, wherein the multiple stacked layers define different surface finishes on the different segments, wherein the multiple stacked layers conform to the shape of the molded component; wherein the first barrier to electrical conductivity is disposed along the front surface of the base substrate, the first barrier to electrical conductivity dividing at least the front surface of the base substrate portion into a first segment and a second segment; whereby a continuous surface of the first segment is discontinuous relative to a continuous surface of the second segment; a base layer of electroless plated metal material disposed on and covering the continuous surfaces of both the first segment and the second segment rendering them electrically conductive and electrically isolated from each other and defining a plateable first base layer segment of electroless plated material and a plateable second base layer segment of electroless plated material separated by the first barrier, wherein the non-plateable material of the first barrier is unplated by the electroless plated metal material and non-conductive and is disposed between the first base layer segment and the second base layer segment; and wherein said first barrier to electrical conductivity does not have said base layer thereon, such that the first base layer segment of electroless plated material covering the first segment is discontinuous and electrically isolated relative to the second base layer segment of electroless plated material covering the second base layer segment; a first decorative metal layer disposed on the first segment over the plateable first base layer segment, the first decorative metal layer adjacent to the first barrier; a second decorative metal layer disposed on the second segment over the plateable second base layer segment disposed thereon, the second decorative metal layer adjacent to the first barrier; wherein the first decorative metal layer and the second decorative metal layer have different surface finish appearances as a direct result of being electroplated via electroplating onto the plateable first base layer segment and the plateable second base layer segment and wherein the first barrier is disposed between the first and second decorative metal layers and completely electrically isolates the first decorative metal layer from the second decorative metal layer.

In one aspect, the first decorative metal layer and the second decorative metal layer have different gloss levels having different distinction of image (DOI).

In one aspect, the different gloss level and DOI is defined by an increased number of pits in a surface of the second decorative metal layer relative to the first decorative metal layer, wherein the pits disturb the surface and cause reflected light to diffuse more than the first decorative metal layer, and the increased number of pits in the second decorative metal layer results from electroplating.

In one aspect, wherein the first decorative metal layer and the second decorative metal layer have different surfaces finishes resulting from electroplating and without post electroplating mechanical alteration.

In one aspect, the first decorative metal layer and the second decorative metal layer have different surfaces defined by the same base metal resulting from different currents applied during electroplating.

In one aspect, the first decorative metal layer wraps around the base substrate and continuously follows a contour thereof along both the front surface and the back surface of the base substrate and over the first plateable base layer; and the second decorative metal layer wraps around the base substrate and continuously follows a contour thereof along both the front surface and the back surface of the base substrate and over the second plateable base layer.

In one aspect, the decorative automotive trim component is fully plated except for along the barrier to electrical conductivity.

In one aspect, the decorative automotive trim component is a one-piece, non-assembled component having the multiple surface finishes.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 is flow diagram of a method of plating a work piece in accordance with an aspect of the disclosure;

FIG. 2 is a side cross-sectional view of a work piece having a barrier formed thereon in accordance with an aspect of the disclosure;

FIG. 3 is a side cross-sectional view of a work piece having a barrier formed thereon in accordance with another aspect of the disclosure;

FIG. 4 is a side cross-sectional view of a work piece having a barrier formed thereon in accordance with a further aspect of the disclosure;

FIG. 5 is a side cross-sectional view of a power source, a first aqueous solution, a first anode and a work piece in accordance with an aspect of the disclosure;

FIG. 6 is a side cross-sectional view of a power source, a second aqueous solution, a second anode and a work piece in accordance with an aspect of the disclosure;

FIG. 7 is a schematic illustration of a plating tool for use in plating a work piece in accordance with an aspect of the disclosure;

FIG. 8 is a process flow diagram illustrating both an electroless plating stage and an electroplating stage;

FIG. 9 is a schematic illustration of a work piece in multiple stages of creating multiple current pathways; and

FIG. 10 is another schematic illustration of a work piece in multiple stages of creating multiple current pathways.

### DESCRIPTION OF THE PREFERRED EMBODIMENTS

Referring to the Figures, wherein like numerals indicate corresponding parts throughout the several views, a method is generally shown for plating a work piece 100 using a power source 102 (e.g., a battery) having a positive terminal 104 and a negative terminal 106. It will be appreciated that a variety of suitable power sources may be employed. According to an aspect, the work piece 100 may be configured as a trim component for a vehicle such as a grill, wheel cover or interior trim piece. It will be appreciated that the work piece 100 may be for a variety of different applications, including furniture applications.

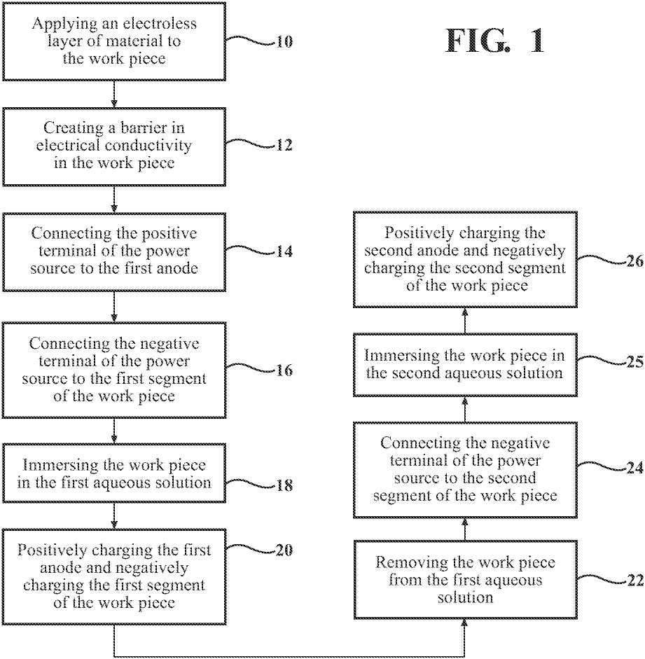

According to an aspect, as exemplarily shown in FIGS. 1-4, the method includes creating a barrier 114 to electrical conductivity in a base substrate layer 110 of the work piece 100. Thereafter, an electroless layer of material 108 can be applied to the base substrate layer 110 of the work piece 100 using an electroless plating process, as generally indicated by reference number 10. As known in the art, the electroless plating process generally includes an autocatalytic chemical reaction which causes a metal to be deposited on the base substrate layer 110 of the work piece 100 such that the substrate layer 110 will be conductive. According to an aspect, the electroless layer of material 108 can act as a base layer that has good adherence to both the substrate layer 110 of the work piece 100 as well as to a subsequently plated decorative or electroplated layer 124, 132, as described illustratively below. Therefore, once the electroless layer of material 108 is adhered to the base substrate layer 110 of the work piece 100, the work piece 100 may be well-suited for receiving subsequent electroplated layers thereon. It should be appreciated that suitable metals for plating (both electroless plating and electroplating) according to the subject method may include, but are not limited to, copper, nickel, zinc, palladium, gold, cobalt, chromium (i.e., chrome), and alloys thereof. Furthermore, the material of the substrate layer 110 of the work piece 100 in accordance with an aspect may be plastic, but other suitable materials for both the metal layers and the substrate could be used without departing from the scope of the subject disclosure. According to another aspect, a non-conductive base substrate layer 110, such as a non-conductive plastic, may be rendered conductive in a variety of other suitable ways. For example, the work piece 100 may include or be formed of a conductive plastic. It will be appreciated that the base substrate and/or the work piece may be formed via an injection molding process. According to a further aspect, a conductive paint may be applied over the base substrate layer 110 such that the part is suitable for receiving subsequent electroplated layers thereon.

According to an aspect, the method can also include creating a barrier 114, 214, 314, 514 in electrical conductivity in the work piece 100 to divide the work piece 100 into a first segment 116 and a second segment 118, with the first and second segments 116, 118 substantially electrically insulated from one another, as generally indicated by reference number 12 (FIG. 1). As a result, a current may flow through each respective first and second segment 116, 118 without flowing through the other. This may also be referred to as creating multiple electric current pathways.

According to an aspect and as exemplarily shown in FIG. 2, a barrier 114 in electrical conductivity in the work piece 100 may be created, formed or disposed on the base substrate layer 110 prior to application of the electroless layer of material 108 to the work piece 100. According to an aspect, the step of creating a barrier 114 in the work piece 100 may include applying a plating resistant coating on the work piece to define the barrier 114 so as to substantially prevent the subsequent deposition of the electroless layer of material 108 on the barrier 114. The plating resist coating may include a non-plateable plastic resin that may be applied to the surface. The plating resist coating may be a polyvinyl chloride material, a polycarbonate material or the like that is applied to the substrate, such as by painting. It will be appreciated that this material should substantially prevent the electroless layer of material 108 from being formed on areas of the base substrate layer 110 that are insulated from the area to which current is applied. It will also be appreciated that a variety of other suitable materials which resist plating may be employed. Such a material may vary depending on what kind of metal is being applied thereon by way of the electroless plating process. It should be appreciated that since the area of the barrier 114 is unable to receive the electroless layer of material 108, after the electroless layer of material 108 is applied on the remaining portions of the work piece 100, the first and second segments 116, 118 of the work piece 100 may each be configured as respective electrical circuits that are isolated from the other. As shown in FIG. 2, according to an aspect, the barrier 114 may be formed on both a front surface 140 and a back surface 142 of the work piece 100 to ensure that they are electrically isolated from one another so long as current between the sections is isolated. While the barrier 114′ is illustrated as disposed opposite the barrier 114, it will be appreciated that they can be offset.

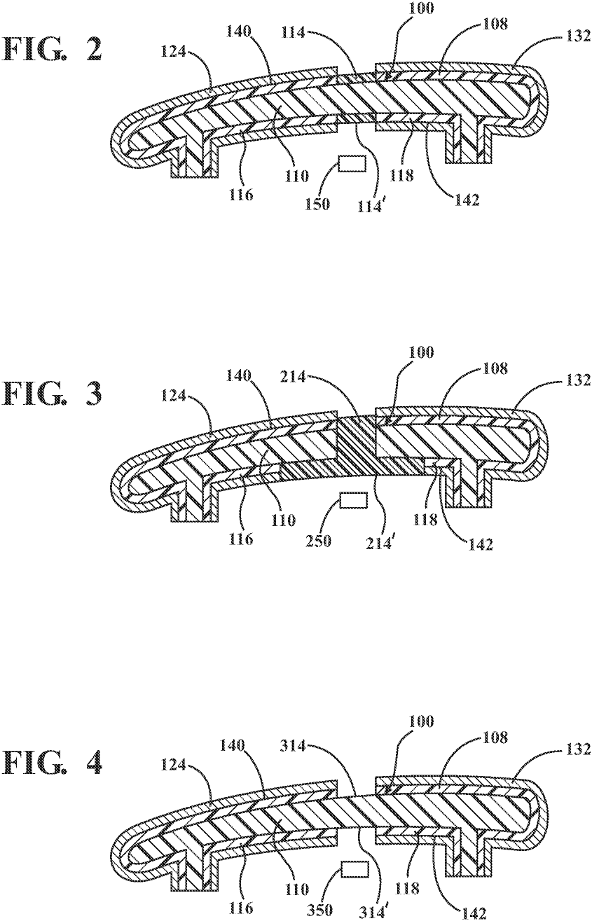

According to another aspect as exemplarily shown in FIG. 3, a barrier 214 in electrical conductivity in the work piece 100 may be created, formed or disposed on the base substrate layer 110 prior to application of an electroless layer of material 108 to the work piece 100. According to a further aspect, the step of creating a barrier 214 in the work piece 100 may include molding a non-plateable material into or onto the work piece 100 to define the barrier 214 so as to substantially prevent the deposition of the electroless layer of material 108 on the barrier 214. Like the plating resistant coating, the non-plateable material may include a non-plateable plastic resin including, but not limited to, a polyvinyl chloride material, a polycarbonate material or the like. Again, this material should substantially prevent the electroless layer of metal from being formed thereon. According to this aspect, the molding process for creating this layer may include a multi-shot injection molding process, a transfer molding process, an over-molding process or the like. It will be appreciated that a variety of other suitable molding processes may be employed. Again, it should be appreciated that since the area of the barrier 214 is unable to receive the electroless layer of material 108, after the electroless layer of material 108 is applied on the remaining portions of the work piece 100, the first and second segments 116, 118 of the work piece 100 may each function as respective electrical circuits that are isolated from one another. As shown in FIG. 3, according to an aspect, the barrier 214 may be formed on both a front surface 140 and a back surface 142 of the work piece 100 to ensure that they are electrically isolated from one another. While the barrier 214′ is illustrated as disposed opposite the barrier 214, it will be appreciated that they can be offset so long as current between the sections is isolated. Additionally, as shown, the barrier 214′ may be larger in size and take up more of the back side 142 surface.

According to a further aspect as exemplarily shown in FIG. 4, the step of creating a barrier 314 in electrical conductivity in the work piece 100 can alternately occur after the electroless layer of material 108 has been applied, and may include removing a portion of the electroless layer of material 108 to define the barrier 314 in electrical conductivity. When the electroless layer of material 108 is removed to create the barrier 314 subsequent electroplated layers will not deposit due to the non-conducting surface under the electroless layer, making the first and second segments 114, 116 of the work piece 100 function as respective, isolated, electrical circuits. The barrier segment of the electroless layer of material 108 may be removed by a mechanical mechanism, chemical dissolution or the like. It will be appreciated that a variety of other suitable removing process may be employed. As shown in FIG. 4, according to an aspect, the barrier 314 may be formed on both a front surface 140 and a back surface 142 of the work piece 100 to ensure that they are electrically isolated from one another. While the barrier 314′ is illustrated as disposed opposite the barrier 314, it will be appreciated that they can be offset so long as current between the sections isolated.

It should be appreciated that any combination of the aforementioned methods may be used to create the barrier 314 in electrical conductivity. According to an aspect, the barrier 314 on the front surface can be formed utilizing one method and the barrier 314′ on the back surface can be formed utilizing another method. For example, the barrier 314 on the front surface can be formed via an injection molding method utilizing a material that is resistant to plating and the barrier 314′ on the back surface can be formed utilizing a spray resist coating. It will be appreciated that a variety of other suitable ways may be employed to create barriers to electrical conductivity.

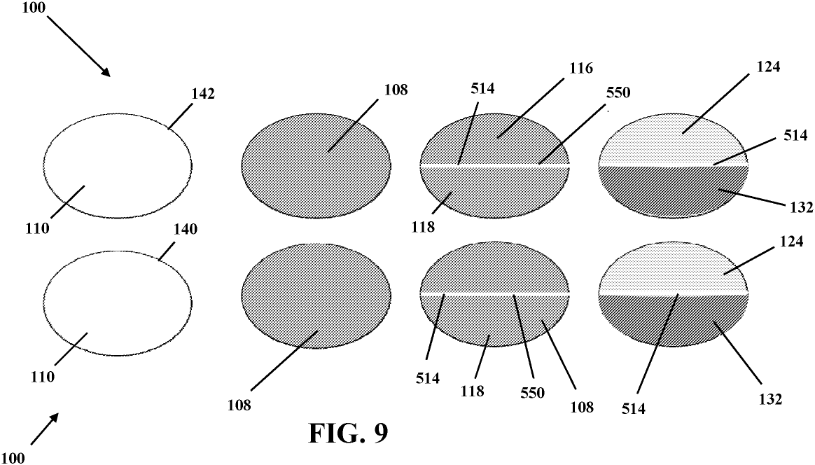

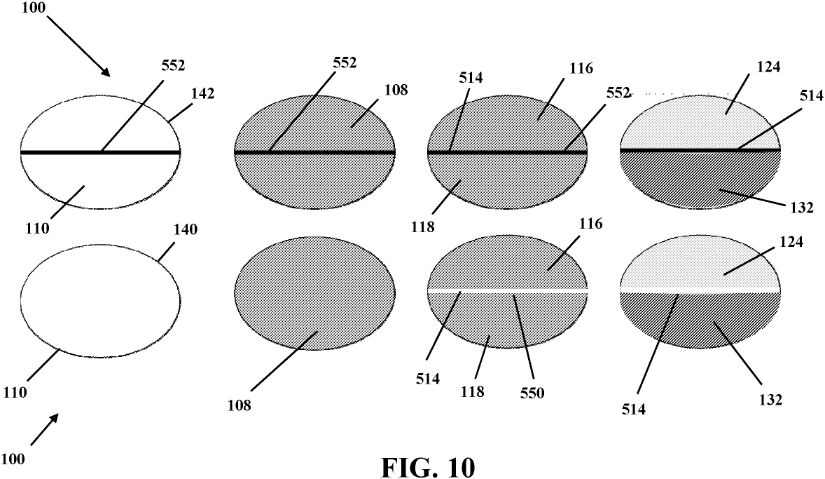

As a result of the non-electrolytic process 600, and as shown in FIGS. 9, and 10, the work piece 100 will include a thin conductive layer 108 of electrolessly deposited Ni or Cu, such that the work piece 100 is substantially encased by this layer 108. The layer 108 may be relatively thin, such that the shape of the work piece 100 is generally the same as it was after being molded. As will be described below, in one aspect, a portion of the work piece 100 may include at least a portion of the barrier 514 prior to the non-electrolytic process, and in such an aspect, the layer 108 will not cover the work piece 100 in the area corresponding to this portion of the barrier 514 that is applied prior to the electroless process 600.

At this point, the rack 402 containing the electrolessly metal deposited work pieces 100 may be removed from the plating line, and the work pieces 100 may be unracked. Individual work pieces 100 may also be processed, and in such instances would not be removed from a rack. The work pieces 100 at this point are in a condition for defining or completing the barrier 514 to create multiple electric current pathways for producing different surfaces finishes.

When initially molded, the work piece 100 is non-conductive, such that current will not flow through the work piece 100. Applying the layer 108 over the work piece 100 converts the work piece 100 into a conductive part, thereby creating a single current pathway when the work piece 100 is encased in the single thin layer 108. Creating and completing the barrier 514 therefore separates the work piece 100 into multiple current pathways. Multiple barriers 514 may be created on the work piece 100 to divide the work piece 100 into multiple segments or zones, each defining a dedicated current pathway. As illustrated, the work piece 100 is separated into segments 116, 118 by barrier 514.

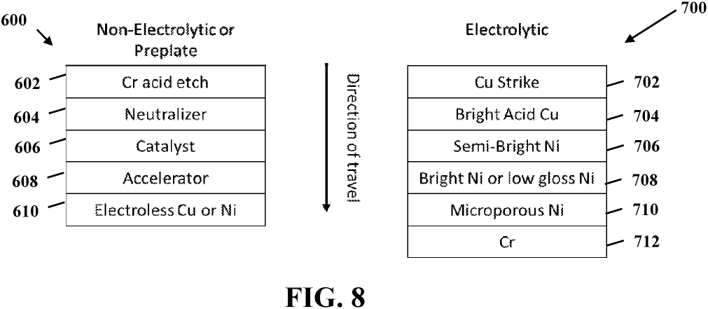

When the work piece 100 has been made conductive via the electroless plating process to create the layer 108, the work piece 100 may thereafter undergo an electrolytic process 700 of plating the work piece 100, as shown in FIG. 8. After the work piece 100 has been divided into multiple segments or zones 116, 118 via the creation of one or more barriers 514, the process of electrolessly plating these different zones 116, 118 defining separate current pathways may proceed. The work pieces 100 may be re-racked and returned to the plating line for the electrolytic stage after the barrier 514 is created. In another aspect, the work pieces 100 may remain secured to the rack 402 during the creation of the barrier 514, and may therefore not need to be re-racked.

With reference again to FIG. 8, common layers may be applied to each of the different zones 116, 118 of the work piece 100. Initially, a Cu strike step 702 may be applied to all of the zones 116, 118, followed by a bright acid Cu step 704, and a semi-bright Ni step 706. Each of the layers applied in these steps 702, 704, 706 may be applied to all zones 116, 118 simultaneously, meaning that multiple zones 116, 118 of the work piece 100 may receive the Cu strike layer at the same time, and then multiple zones may receive the bright acid Cu layer.

After the semi-bright Ni layer has been applied and deposited to all zones, further layers can be applied separately to individual zones. In a further step 708 bright Ni or low gloss Ni may be applied to one of the zones 116/118 of the work piece 100. More particularly, the zone 116/118 where plating is desired may be included in the electroplating circuit (described in further detail below). The separated current pathways defined by the barrier 514 will electrically isolate the selected zone 116/118 from the other zones 116/118. Accordingly, as current passes through the attached zone 116/118, current will not pass through to the other zones 116/118, and these other zones 116/118 will not be plated. In a further step 710, Microporous Ni may be applied to a selected zone. In another step 712, Chromium may be applied, such as hex-Chromium and trivalent Chromium.

After application of the various layers and intermediate layers of the process 700, separate electroplated layers 124, 132 are therefore deposited on the layer 108.

It will be appreciated that various combinations of surface finishes may therefore be applied to a single work piece 100 that was initially molded as a non-conductive plateable plastic such as PCABS or ABS. By encasing the entire work piece 100 in an electrolessly plated layer 108 of Cu or Ni, the work piece 100 becomes conductive. By creating the barrier 514, the work piece 100 can be separated into separate electrically isolated zones 116, 118 with separate current pathways, such that the work piece 100 has multiple current pathways. The barrier creation may occur, in this aspect, after rendering the entire workpiece conductive. The work piece 100 does not need to be created using a multi-shot molding process that includes both plateable and non-plateable portions to define a barrier. Similarly, a separate non-plateable portion of the work piece 100 does not need to be attached to a plateable portion of the work piece 100 prior to electroless plating. However, as described further below, in another aspect the work piece 100 may include application of a resist material prior to electroless plating.

In one aspect, after electroless deposition, the barrier 514 may be created via laser ablation prior to the electroplating stage. In this aspect, laser ablation is used to remove a portion of the electrolessly deposited layer 108. The laser ablation may be used to create the entire barrier 514 or a portion of the barrier 514 (with the remaining portion of the barrier 514 being created by the resist material, described in further detail below). Thus, in one aspect, after the entire workpiece is rendered conductive via electroless plating, the laser ablation removes a portion of the conductive layer 108 such that the entire workpiece is no longer part of a single circuit.

With regard to the laser ablation for creating at least a portion of the barrier 514, this step of creating the barrier 514 in electrical conductivity in the work piece 100 can occur after the electroless layer of material 108 has been applied, and includes removing a portion of the electroless layer of material 108 to define the barrier 514 in electrical conductivity. When the electroless layer of material 108 is removed to create the barrier 514, subsequent electroplated layers will not deposit in the removed area due to the non-conducting surface of the non-plateable resin under the electroless layer, making the first and second segments 116, 118 of the work piece 100 function as respective, isolated, electrical circuits, thereby creating multiple current pathways.

FIG. 9 illustrates a schematic representation of the barrier 514 being created on the work piece 100 having the electroless plated layer 108 applied to the workpiece. FIG. 9 illustrates both a front side 140 and a back side 142 of the work piece 100 through various phases of the plating process 600, 700 using multiple current pathways. The process proceeds from left to right in FIG. 9, with the back side 142 of the work piece 100 shown at the top and the front side 140 of the work piece 100 shown at the bottom.

The left side of FIG. 9 illustrates the work piece 100 prior to electroless plating. Both the back side 142 of the work piece 100 and the front side 140 of the work piece are free of deposited material thereon. The work piece 100 in this representation illustrates the plastic material of the work piece 100 after being molded to the desired shape, which may also be referred to as the base substrate layer 110. In this schematic representation, the work piece 100 has an oval shape. It will be appreciated that various other shapes may also be used, and the oval shape is used for illustrative purposes.

Moving from left to right in FIG. 9, the second set of representations illustrates the work piece 100 after the electroless layer 108 has been applied over the work piece 100. Both the front side 140 and the back side 142 of the work piece 100 are shown covered by the electroless deposited layer 108. The conductive metal material, such as Cu or Ni, makes the entire work piece 100 conductive, such that a single current pathway exists.

The third set of representations illustrates a path 550 along which laser ablation has been performed. The path 550 is shown in FIG. 3 as being a generally straight line extending in a direction from left to right. The barrier 514 is therefore created and disposed along the path 550. The first segment/zone 116 is defined on one portion of the work piece 100, and a second segment/zone 118 is defined on another portion of the work piece 100. The barrier 514 separates the first and second zones 116, 118. The first zone 116 is electrically isolated from the second zone 118 after creation of the barrier 514 via laser ablation.

The laser ablation process removes a portion of the electrolessly deposited layer 108 from the work piece 100 along the path 550. The barrier 514 may therefore be in the form of a recess, cavity, or trough defined along the path 550 because material was removed from layer 108. However, layer 108, as described above, is substantially thin, so the recess, cavity, or trough is generally shallow. The plateable resin material of the base substrate layer 110, such as PCABS or ABS, may therefore be visible along the path 550. Current passing through the metal material of the layer 108 in first zone 116 will not pass through to the second zone 118, and vice versa, because the base substrate layer 110 is non-conductive and layer 108 is interrupted by the barrier 514.

The fourth set of representations illustrates the work piece 100 after electroplating has occurred. The first zone 116 includes first electroplated layer 124 having a first material. The second zone 118 includes second electroplated layer 132 having a second material. As shown, the first zone 116 has a different surface appearance than the second zone 118. However, it will be appreciated that the different zones may also have the same material and have the same appearance, if each zone is plated with the same material.

In one aspect, the difference surface appearances in zones 116 and 118 may be formed from the same base metal, and may be a result of immersion of the workpiece 100 in a common bath/solution having the same base metal, with different currents applied to the isolated segments to create the different finish from the same base metal. Multiple workpieces 100 may be attached to a common rack and immersed simultaneously. Put another way, a single tank having a single solution may receive the workpiece 100 (or multiple workpieces) having both zones 116 and 118, and different, separate currents generated by separate rectifiers may be applied to these zones 116 and 118 that are both immersed in the common tank.

The laser ablation process may be performed while the work pieces 100 are held in the rack 402. The laser ablation may therefore be performed without removing the work pieces 110 from the rack 402. By performing the laser ablation without removing the work pieces 100 from the rack 402, additional time can be saved in the overall plating process.

To ablate and remove the material from the work piece 100, the laser ablation may require a manner of accessing the side of the work piece 100 that faces the tooling or structure of the rack if the work pieces 100 are to remain on the rack during the ablation procedure. In some cases, the path 550 of the ablation may be difficult to access while the work piece 100 remains on the rack 402. In this case, the work pieces 100 may be removed to improve access to the desired path 550 for ablation. Even if the work piece 100 is removed, the laser ablation process still provides advantages relative to multi-shot molding process or processes involving the assembly of multiple types of plateable and non-plateable materials. For example, the laser ablation process allows for intricate designs for the path 550 that may not be possible by the use of masking or resist layers. Accordingly, improved aesthetics on the front side, which is the side that is typically visible on a decorative component, may be accomplished via the laser ablation method.

In another aspect, the barrier 514 may be formed on the work piece 100 through a combination of laser ablation and the use of a resist material 552. As described above, performing laser ablation on a back side of the work piece 100 can be difficult when the work pieces 100 are held on a rack or similar structure. Thus, as an alternative to using laser ablation on each side of the work piece 100, a portion of the barrier 514 may be created on the backside using the resist material 552. While the resist material 552 may not provide the same preciseness of the laser ablation, the back side may not typically be visible and such preciseness may be less important on such a non-visible side. Thus, depending on the particular design, the operator may determine whether to use resist material or laser ablation on the back side.

With further reference to the resist material 552, the portion of the barrier 514 in electrical conductivity in the work piece 100 may be created, formed or disposed on the base substrate layer 110 prior to application of the electroless layer of material 108 to the work piece 100. According to an aspect, the step of creating a barrier 514 in the work piece 100 may include applying a plating resistant material 552 on the work piece to define the barrier 514 so as to substantially prevent the subsequent deposition of the electroless layer of material 108 on the barrier 514 during the non-electrolytic process 600. The plating resist material 552 may include a non-plateable plastic resin that may be applied to the surface. The plating resist material 552 may be a polyvinyl chloride material, a polycarbonate material or the like that is applied to the substrate, such as by painting, a mask and spray process, or application of a bead of material. It will be appreciated that this material should substantially prevent the electroless layer of material 108 from being formed on areas of the base substrate layer 110 that are insulated from the area to which current is applied. It will also be appreciated that a variety of other suitable materials which resist plating may be employed. Such a material may vary depending on what kind of metal is being applied thereon by way of the electroless plating process. It should be appreciated that because the area of the resist material 552 is unable to receive the electroless layer of material 108, after the electroless layer of material 108 is applied on the remaining portions of the work piece 100, the first and second segments 116, 118 of the work piece 100 may each be configured as respective electrical circuits that are isolated from the other, thereby creating multiple current pathways when the barrier 514 is completed. However, when the barrier 514 is not completed (such as via a closed loop), the segments 116 and 118 are not yet isolated, for example when resist material 552 is applied only to one side of the work piece.

As shown in FIGS. 9 and 10, according to an aspect, the resulting completed barrier 514 (after path 550 has been ablated) may be formed on both front surface 140 and back surface 142 of the work piece 100 to ensure that they are electrically isolated from one another so long as current between the sections is isolated. While the barrier 514 on one side of the work piece 100 is illustrated as disposed opposite the barrier 514 on the other side of the work piece 100, it will be appreciated that they can be offset. FIG. 9 illustrates creation of the barrier 514 without using the resist material 552, and FIG. 10 illustrates creation of the barrier 514 with the resist material 552 on one side of the work piece.

As described above, the resist material 552 may be applied to the work piece 100 prior to the work piece 100 undergoing the plating process. More particularly, the resist material 552 may be applied to the work piece 100 prior to the electroless plating process and prior to creation of the layer 108. FIG. 10 illustrates the plating process for the front side 140 and the back side 142 of the work piece 100 via multiple representations, moving from the left to right in the figure. After molding the work piece 100, which may be in the form of a single part or component, the resist material 552 may be applied to the back side 142 of the work piece 100. The resist material 552 may be applied in different ways, as further described below.

In one aspect, the resist material 552 may be applied robotically at the molding press. In one aspect, a bead of the resist material 552 may be laid on the work piece 100, for example of the back side 142. In one aspect, the resist material 552 may cure in place on the work piece 100.

In another aspect, the resist material 552 may be applied using a mask and spray procedure. In this aspect, a mask may be placed over the work piece 100, covering the portions of the work piece 100 that will later be plated. The mask will leave exposed the location where the resist material 552 is to be applied. Following application of the mask, the resist material 552 may be sprayed on the part, such that the resist material 552 will adhere to the work piece 100 corresponding to the portions exposed through the mask.

In the mask and spray procedure, the resist material 552 may be applied as an aqueous based resist paint. The resist material 552 may cure in place at room temperature, or through an oven over a short period of time.

Upon application of the resist material 552 to the work piece 100, the work piece 100 may undergo a similar procedure described above for the electroless deposition of the thin metal layer 108. As a result of the electroless deposition, the layer 108 will be present on the front side 140 of the work piece 100. In one aspect, the layer 108 will cover substantially the entire surface area of the front side 140 of the work piece 100.

Additionally, as a result of the electroless deposition, the layer 108 will be present over a portion of the back side 142 of the work piece 100. However, unlike the front side 140 of the work piece 100, the layer will not cover substantially the entire surface of the back side 142 of the work piece 100. Rather, the area of the back side 142 of the work piece 100 including the resist material 552 will be free from the layer 108. The resist material 552 is configured to resist electroless deposition, and as such the metal material of the layer 108 will not be deposited on the resist material 552. The resist material 552 therefore creates a portion of the barrier 514 on the backside 142 of the work piece 100 after the electroless deposition process and prior to laser ablation.

With a portion of the barrier 514 resulting from the presence of the resist material 552, the laser ablation process can then be performed on the front side 140 of the work piece 100, in a manner similar to that described above. The barrier 514 may therefore be a combination of the resist material 552 and the removed material along the path 550 of the laser ablation.

It will be appreciated that various patterns and combinations of resist material 552 and laser ablation may be used to create various shapes, lines, patterns, or the like to create separate and electrically isolated zones on the layer 108 deposited on the work piece 100. Accordingly, the straight line illustrated in the figures shall be considered one example of creating separate zones of the work piece 100.

Additionally, the resist material 552 need not be limited only to the back side 142 of the work piece 100 or portions of the work piece 100 that are difficult to access when the work piece 100 is in placed on the rack. For example, the resist material 552 may be applied to both the front side 140 and the back side 142 of the work piece 100. In some cases, it may be desirable to create a continuous path or bead of resist material 552 that extends fully around the work piece 100, with additional laser ablation being performed on accessible areas. The resist material 552 may also be used to create the entire desired barrier 514 on the work piece 100, and no laser ablation may be used.

The use of the resist material 552 over some portions of the work piece 100 can therefore enable the work pieces 100 to remain secured to the rack, thereby saving processing time and cost in the creation of separate electrically isolated zones of the work piece 100. However, it will be appreciated that after applying the resist material 552, the work pieces 100 may still be removed from the rack to perform the laser ablation procedure, if desired, with laser ablation being performed on any area of the work piece 100, including the back side or the side where the resist material 552 is disposed.

Following the creation of the desired barrier 514, the work piece 100 may undergo the electroplating process described above, in which the multiple current pathways created by the barrier 154 may be used to selectively plate the portion or zone of the work piece 100 that is part of the active circuit, with the separate and non-connected zones not receiving further plating. As described above, each of the zones may be activated simultaneously during the Cu Strike, Bright Acid Cu, and Semi-Bright Ni portions of the electroplating process.

The use of laser ablation to create the barrier 514, or the use of laser ablation in addition to the resist material 552 to complete the barrier 514, therefore allows for the overall plating process to be performed quickly and with fewer assembly stages. A single shot molding process using plateable resin may be used to form the part, without requiring a second shot of non-plateable resin to create a barrier to plating. Similarly, multiple plateable resin components and non-plateable resin components need not be assembled. Rather, after molding the work piece 100, the work pieces 100 may simply proceed to the electroless deposition stage if no resist material 552 is to be applied, or the resist material 552 can be easily applied as a cure-in-place bead of material or in a mask-and-spray process. The laser ablation to remove the layer 108 resulting from electroless deposition can therefore define or complete the desired barrier 514 after the electroless metal deposition stage and prior to the electroplating step for the electrically isolated zones. Thus, the work piece 100 may include multiple current pathways through the creation of the barrier 514 as described above.

Further details regarding the plating process for the work piece 100 after the barrier 514 is created are described below. In particular, details regarding the application of a current to the first and second segments 116, 118 that are electrically isolated are included below.

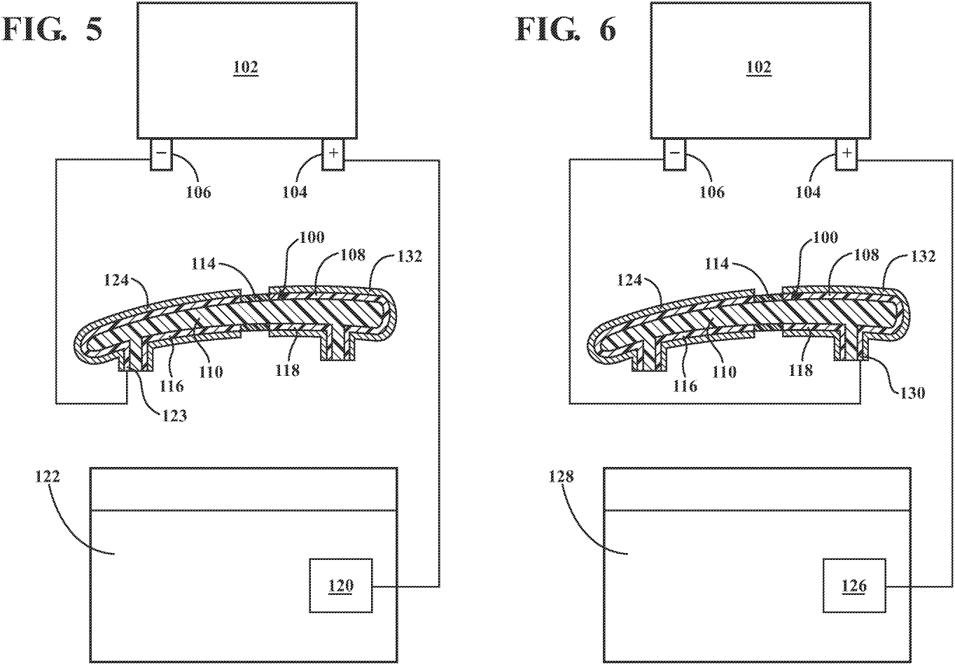

According to an aspect, as shown FIGS. 1 and 5, the method may proceed with the step of connecting the positive terminal 104 of the power source 102 to a first anode 120, as generally indicated by reference number 14 (FIG. 1). The first anode 120 may be made of a metal material and may be placed in a first aqueous solution 122 with current being applied to the first anode 120. The first anode 120 may be soluble, where the material will dissolve into a first aqueous solution 122 as current is passed through it or insoluble, where the anode material will not dissolve into the solution as current is applied therethrough. It will be appreciated that the first anode 120 could be constructed of a metal material, which may be utilized to form a first decorative surface or layer on the first portion or segment 116 of the work piece 100. The metal material or first decorative surface may include, but is not limited to, copper, nickel, zinc, palladium, gold, cobalt, chromium (i.e., chrome), and alloys thereof. According to an aspect, the metal material from the first anode 120 may be used directly for plating purposes on the work piece 100. Alternatively, the plating to the work piece 100 can occur from the metal ions available in the first aqueous solution 122, as will be understood by one of ordinary skill in the art. The first anode 120 may be in the form of a solid mass of material that is insoluble or soluble, while the plating solution is composed of a plurality of metal salts necessary to achieve the desired plated layer.

According to aspect, the method proceeds with connecting the negative terminal 106 of the power source 102 to a first point of contact 123 on the first segment 116 of the work piece 100, as generally indicated by reference number 16 (FIG. 1). The work piece 100 may then be immersed in the first aqueous plating solution 122 which may contain metal salts and the first anode 120, as generally indicated by reference number 18. After the work piece 100 has been immersed in the first aqueous solution 122, the method can proceed with 20 positively charging the first anode 120 and negatively charging the first segment 116 of the work piece 100 to cause the metal ions in the first aqueous solution 122, to be reduced to their metallic state at the solution interface of the first segment 116. A layer of metal may then form on the first segment 116 because it is the only location on the work piece 100 that has a supply of electrons to reduce the metal salts to their respective metal state (i.e., Cu²⁺ + 2e→Cu⁰). Because there is no supply of electrons on the second segment 118 (since it is electrically isolated), metal ions in the first aqueous solution 122 cannot be reduced to their metallic state.

According to another aspect, as shown in FIGS. 1 and 6, the method can then continue with the step of removing the work piece 100 from the first aqueous solution 122 and connecting the positive terminal 104 of the power source 102 to a second anode 126, as generally indicated by reference number 22 (FIG. 1). Similar to the first anode 120, the second anode 126 may be made of a metal material, which may be utilized to form a second decorative surface or layer on the second portion or segment 118 of the work piece 100. The first decorative surface and the second decorative surface may be different from one another. Also, like the first anode 120, the metal material or second decorative surface from which the second anode 126 can be comprised may include, but is not limited to, nickel, zinc, palladium, gold, cobalt, chromium (i.e., chrome), and alloys thereof. It will be appreciated that a variety of other suitable materials may also be employed. According to an aspect, the second anode 126 may be of a different metal than the metal of the first anode 120. Also like the first anode 120, the second anode 126 may be in the form of a solid mass of material that is insoluble or soluble, while the plating solution 128 is composed of a plurality of metal salts necessary to achieve the desired plated layer. It will be appreciated that different metal finishes can also be achieved utilizing the same anodes such as for example with a Bright Chrome part and a Satin Chrome part.

According to a further aspect, the method can then proceed with connecting the negative terminal 106 of the power source 102 to a second point of contact 130 on the second segment 118 of the work piece 100, as generally indicated by reference number 24 (FIG. 1). The work piece 100 may then be immersed in the second aqueous solution 128 which contains the second anode 126, as generally indicated by reference number 25 (FIG. 1). After the work piece 100 has been immersed in the second aqueous solution 128, the method can continue with positively charging the second anode 126 and negatively charging the second segment 118 of the work piece 100 to cause metal ions from the second plating solution 126 to be passed onto the electroless layer 108 on the second segment 118 of the work piece 100 to form a second electroplated layer 132 on the second segment 118, as generally indicated by reference number 26. It should be appreciated that a metal layer only forms on the second segment 118 of the work piece 100 because the first and second segments 116, 118 are electrically insulated from one another by the barrier 114, 214, 314, 514.

As a result of the aforementioned steps, after the second electroplated layer 132 of metal has been formed on the second segment 118 of the work piece 100, the first and second segments 116, 118 may have different metallic finishes. It should further be appreciated that additional barriers 114, 214, 314, 514 in conductivity could be made on the work piece 100 to provide additional segments that are electrically insulated from one another. Such additional segments could be electroplated in accordance with the aforementioned steps to provide for more than two segments of the work piece 100 that have different metallic finishes.

According to a still further aspect, to improve adherence of the first and second electroplated layers 124, 132 to the work piece 100 and to improve the structural properties of the work piece 100, an intermediate electrolytic layer of copper from an acid copper plating solution may be applied to both the first and second segments 116, 118 after the electroless layer of material 108 is applied to the work piece 100, and prior to electroplating the first and second electroplated layers 124, 132 as described above. Applying this intermediate layer can build the metal thickness to a level that is sufficient to carry the current for electroplating of subsequent metal layers. After the intermediate copper layer has been electrodeposited to a sufficient thickness, an intermediate layer of sulfur-free nickel may be electroplated onto the copper surface to protect the copper from corrosion on all electrical pathways on the part. After the deposition of the intermediate layer of sulfur-free nickel is electroplated on the work piece, there can be a significant amount of metal to carry current, and the copper layer is protected. Therefore, the work piece 100 can be immersed in any suitable plating solution and electroplated as described above to provide the first and second electroplated layers 124, 132 to achieve the desired finishing effect. It should be appreciated that the method could alternatively proceed without these steps and other materials could be used in these steps in place of those described. It will additionally be appreciated that intermediate layers consisting of different materials could be applied to the first and second segments 116, 118 to provide different appearances for the work piece 100.

According to a further aspect of the present disclosure, after a barrier 114, 214, 314, 514 is created as described above to electrically isolate multiple sections of a work piece 100, an electrophoretic coating may be selectively deposited on at least one of the sections of the work piece 100 in order to create different aesthetic affects. It will be appreciated that the deposition of the electrophoretic coating may occur in connection with the deposition of one or more different metal layers as discussed above. It will be appreciated that different electrophoretic coatings may be selectively deposited in the same fashion discussed above such that one electrophoretic coating may be applied to one section of a part without it being applied to another section of the part because the segments are isolated.

According to a still further aspect of the present disclosure, as the barriers can be formed on both the front side 140 and the back side 142 of the work piece 100, metal layers are not deposited over the area corresponding to the barrier, as discussed above. As shown in the Figures, a light source 150, 250, 350 may be disposed behind the work piece 100 and positioned to emit light into and through the barriers 114, 214, 314, 514 to provide a backlighting effect, as shown, to enhance aesthetics. It will be appreciated that the use of a transparent or translucent material at the barrier 114, 214, 314, 514 can assist with this effect, although non-translucent or non-transparent materials may also be employed. Alternatively, the work piece 100 may be formed of resins of different colors to provide additional aesthetic affects.

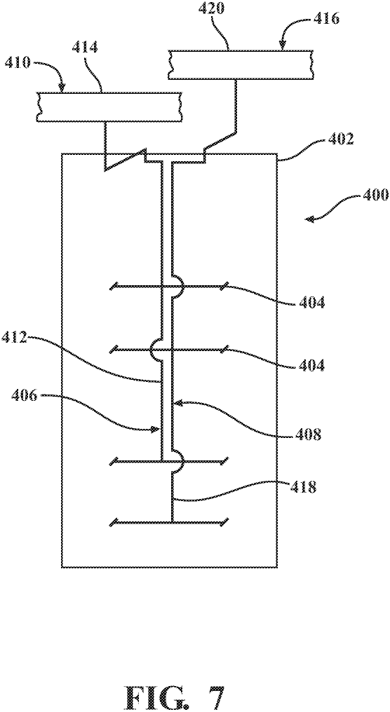

FIG. 7 illustrates a plating tool 400 in accordance with an aspect of the disclosure. As shown, the tool 400 can include a plating rack 402 with a plurality of rack tabs 404, which are configured to hold individual work pieces that are to be subjected to a plating process. According to an aspect, the plating tool 400 can include multiple current pathways, which may be referred to as a first circuit 406 and a second circuit 408. Each of the first circuit 406 and the second circuit 408 can be selectively actuated such that each of the circuits can be active at separate times as desired. According to another aspect, the first circuit 406 can be configured such that it is in communication with a first segment 116 of the work pieces 100 located on the rack tabs 404 of the plating rack 402 such that current is applied thereto to effectuate plating a metal layer onto the first segment 116. This allows for first segments of multiple work pieces to be subjected to a plating process simultaneously. According to a further aspect, the second circuit 408 can be configured such that it is in communication with a second segment 118 of the work pieces 100 located on the rack tabs 404 of the plating rack 402 such that current is applied thereto to effectuate plating of a separate metal layer onto the second segment 118. This allows for second segments of multiple work pieces to be subjected to a plating process simultaneously. It will be appreciated to more than two circuits can be integrated into the plating rack 402 to accommodate plating multiple different metal layers onto a surface of the work piece 100.

According to an aspect, the first circuit 406 can include a first power source 410, a first cathode 412 and a first connector bushing 414. The first power source 410 can provide power to the first cathode 412 to charge at least a portion of one or more work pieces. The first power source 410 may be in communication with the first cathode 412 via the first connector bushing 414. According to a further aspect, the first cathode 412 may be integrated into the plating rack 402. According to a still further aspect, the second circuit 408 can include a second power source 416, a second cathode 418, and a second connector bushing 420. The second power source 416 can provide power to the second cathode 418 to charge at least a portion of one or more work pieces. The second power source 416 may be in communication with the second cathode 418 via the second connector bushing 420. The second cathode 418 may also be integrated into the plating rack 402.

According to an aspect, each of the circuits 406, 408 may be electrically insulated from each other. Additionally, each of the circuits 406, 408 can connect to separate power sources such that each of the circuits can be activated individually or simultaneously as desired. The use of separate circuits allows for the plating of different metals on a single work piece. According to a further aspect, the plating rack 402 may be coated with a plate resistant coating to prevent rack plate-up as well as rack damage. The plate resistant coating may be Platisol, however, a variety of other suitable coatings may be employed.

It will also be appreciated that an auxiliary anode may also be incorporated into the tooling to assist in the deposition of metal in areas where the electrical current density is limited, such as recessed areas.

As described above, the work piece 100 may have separate segments 116 and 118 that are electrically isolated relative to each other. In one aspect, multiple layers of material may be applied via an electroplating process. These multiple layers of material may be applied to one of the segments 116 or 118. For example, multiple layers of material may be applied to the first segment 116. Additionally, multiple layers of material may be applied to the second segment 118. The segments 116 and 118 may be plated separately, by removing the work piece 100 from the first aqueous solution 122 and then placing the work piece 100 in the second aqueous solution 128.

However, in another aspect, the work piece 100 may remain immersed in the first aqueous solution 122, and the first segment 116 may be plated by running a current through the first circuit 406 at a first time, and then the second segment may be plated by running a current through the second circuit 408 at a second time without removing the work piece 100 from the first aqueous solution 122. It will be appreciated that the first aqueous solution 122 is used for both segments 116, 118, and the first aqueous solution 122 is not limited for use with the first segment 116. In this aspect, the first aqueous solution 122 may replace the second aqueous solution 128, and the first aqueous solution may be considered a common bat/solution.

The above description has referred to a first circuit 406 and a second circuit 408. However, it will be appreciated that there may be more than two separate circuits, and that the use of multiple circuits is not limited to two.

In one aspect, multiple separate circuits may be attached to the first segment 116, to allow for plating multiple layers of material on the first segment 116 using multiple rectification sources. In one aspect, a first layer of a first metal material may be applied to the first segment 116 via a first circuit via a first rectification source, and a second layer of a second metal material may be applied to the first segment 116 via a second circuit via a second rectification source.

In one aspect, the plating process can include applying a first current via a first circuit that includes the first segment 116, and the plating process further includes applying a second current via a second circuit that includes the second segment 118. The plating process may include creating a first metal surface on the first segment 116 that includes a first plurality of metal layers having a first surface finish. The plating process may include creating a second metal surface on the second segment 118 that includes a second plurality of metal layers having a second surface finish. The first and second metal layers and surface finishes may therefore be formed of the same base metal from the same solution.

In one aspect, the first current and the second current are applied simultaneously to the first and second metal surfaces such that at least one of the first metal layers and at least one of the second metal layers are deposited on the work piece 100 at the same time. In one aspect, the work piece 100 remains within the same aqueous solution as the first and second currents are applied. Different surface finishes may be defined by applying relatively higher/lower voltages/currents to the first and second segments.

In one aspect, the first circuit 406 is connected to the first power source 410, and the second circuit 408 is connected to the second power source 416. The first and second power sources 410, 416 may be activated simultaneously, as described above. When activated simultaneously, common metal layers may be applied to the first segment 116 and second segment 118 at the same time. The first and second power sources 410, 416 may also be activated individually. When activated individually, metal layers may be applied to the first segment 116 and second segment 118 at different times such as sequentially.

In one aspect, the first segment 116 may be part of a circuit that includes the first power source 410 and may also be part of a circuit that includes the second power source 416. Accordingly, when the first power source 410 is activated, a first metal layer of a first type may be applied to the first segment 116, and when the second power source 416 is activated, a second metal layer of a second type may be applied to the first segment 116. Similarly, the second segment 118 may be part of a circuit with both the first power source 410 and the second power source 416.

The use of separate power sources and separate rectifiers therefore allows for different types of metal layers to be applied easily and efficiently without requiring removal of the work piece 100 from the common solution in which it is disposed. The work piece 100 need not be removed and placed in a different solution and connected to a different circuit. The segments 116 and/or 118 may be attached to multiple circuits, and selective activation of the rectifiers may be used to control which segment is plated and/or which type of surface finish is applied, depending on the circuit that activated and the voltage/current.

As stated above, different metal finishes may be achieved utilizing the same anodes. For example, a bright chrome finish may be achieved using the same anode that produces a satin chrome finish by utilizing different rectifiers and different circuits.

Thus, in one aspect, the first and second metal surfaces created on the work piece 100 have the same base metal. The base metal may be disposed in the first aqueous solution 122 in which the work piece 100 is disposed. The first metal surface may be bright chrome, and the second metal surface may be a different metal surface having the same base metal as bright chrome (e.g. satin chrome).

The first segment 116 may be part of a first circuit that includes the first power source 410, and the second segment 118 may be part of a second circuit that includes the second power source 416. The work piece 100 and both the first segment 116 and the second segment 118 may be disposed in the first aqueous solution 122 that includes the same base metal for creating a bright chrome and/or satin chrome and/or other finish arising from the same base metal. The first and second power sources 410 and 416 may be activated simultaneously, sequentially, or during an overlapping period of time. The first segment 116, being electrically isolated from the second segment 118, will receive one type of surface finish according to the first power source 410. The second segment 118, being electrically isolated from the first segment 116, will receive a different type of surface finish according to the second power source 416. These different surface finishes may be achieved without removing the work piece 100 from the first aqueous solution 122.

In one aspect the first segment 116 may be part of a first circuit that includes the first power source 410. The first segment 116 may also be part of a second circuit that includes the second power source 416. The work piece 100 maybe disposed in the first aqueous solution 122 that includes the same base metal. The first circuit may be activated to produce a first type of metal layer on the first segment 116 from the base metal of the solution 122. The second circuit may then be activated to produce a second type of metal layer on the first segment 116 from the base metal of the solution 122.

The above description has referred to the creation of the workpiece 100 by defining the barrier 114, 214, 314, 514 as described above, and with electroless deposition on the base substrate 110. In one aspect, the base substrate layer 110 or body of the workpiece may be single piece of unitary construction. Put another way, the molded plastic material forming the general shape of the workpiece to be plated is a single piece, and is not assembled as multiple pieces. Thus, different surface finishes may be achieved for the unitary workpiece base structure.

The above described methods for creating multiple electric current pathways in a decorative work piece 100 accordingly result in unique products with unique surface finishes and aesthetics that are not possible according to earlier methods.

In one aspect, a decorative automotive component 100 is provided by various one or more of the above methods. In one aspect, the decorative automotive component 100 may be in the form of a molded component 100 having a molded base substrate 110 with a first barrier 114, 214, 314, 514 to electrical conductivity disposed therealong. The molded component 100 has a front surface 140 and a back surface 142 opposing the front surface

In another aspect, the decorative automotive component 100 may be in the form of an integrally molded component 100 having a molded base substrate 110 integrally molded with a molded first barrier to electrical conductivity. The integrally molded component 100 has a front surface 140 and a back surface 142 opposing the front surface.

In both of these aspects, the molded component 100 with the barrier 114, 214, 314, 514 is distinguishable from automotive components that are assembled together from different pieces that each have different surface finishes to ultimately form an assembled decorative automotive component. The present disclosure provides one-piece unitary construction with different surface finishes 124, 132.

The base substrate 110 is formed of a plastic metal plateable material. The base substrate 110 and the first barrier to electrical conductivity combine to define a single molded unitary structure defining the overall shape of the molded component or integrally molded component, upon which multiple stacked layers are applied to different segments. The multiple stacked layers 108, 124, 132 define different surface finishes 124, 132 on the different segments. The multiple stacked layers 108, 124, 132 conform to the shape of the molded component or integrally molded component.

In one aspect, the first barrier 114, 214, 314, 514 to electrical conductivity is disposed along at least the front surface 140 of the base substrate. In one aspect, the molded first barrier to electrical conductivity is in the form of a non-plateable material molded into or onto at least the front surface 140 of the base substrate portion.

The first barrier 114, 214, 314, 514 to electrical conductivity divides at least the front surface 140 of the base substrate portion 110 into a first segment 116 and a second segment 118, whereby a continuous surface of the first segment 116 is discontinuous relative to a continuous surface of the second segment 118.

A base layer 108 of electroless plated metal material is disposed on and covers the continuous surfaces of both the first segment 116 and the second segment 118, rendering them electrically conductive and electrically isolated from each other. The base layers 108 on each segment 116, 118 thereby define a plateable first base layer segment 116 of electroless plated material and a plateable second base layer segment 118 of electroless plated material separated by the first barrier 114, 214, 314, 514. The non-plateable material or area of the first barrier or molded first barrier is unplated by the electroless plated metal material and non-conductive and is disposed between the first base layer segment 116 and the second base layer segment 118.

The first barrier 114, 214, 314, 514 to electrical conductivity does not have said base layer 108 thereon, such that the first base layer segment of electroless plated material covering the first segment 116 is discontinuous and electrically isolated relative to the second base layer segment of electroless plated material covering the second base layer segment 118.

A first decorative metal layer 124 is disposed on the first segment over the plateable first base layer segment 116, and the first decorative metal layer is adjacent to the first barrier 114, 214, 314, 514. A second decorative metal layer 132 is disposed on the second segment over the plateable second base layer segment 118 disposed thereon, and the second decorative metal layer 132 is adjacent to the first barrier 114, 214, 314, 514.

The first decorative metal layer 124 and the second decorative metal layer 132 have different surface finish appearances as a direct result of being electroplated via electroplating onto the plateable first base layer segment and the plateable second base layer segment and wherein the first barrier 114, 214, 314, 514 is disposed between the first and second decorative metal layers and completely electrically isolates the first decorative metal layer 124 from the second decorative metal layer 132.

The first decorative metal layer 124 and the second decorative metal layer 132 may have properties resulting from being formed of the same metal material or alloys thereof, being electroplated via electroplating onto the plateable first base layer segment 116 and the plateable second base layer segment 118, where the first barrier 114, 214, 314, 514 is disposed between the first and second decorative metal layers 124, 132 and completely electrically isolates the first decorative metal layer 124 from the second decorative metal layer 132. The properties described herein refer to properties specific to electroplating, such as a different appearance, gloss level, distinction of image, and/or color, with the differences being the result of electroplating the two electrically isolated segments 116, 118. In one aspect, one such property is a different distinction of image for the two isolated surface finishes 124, 132 despite using the same base metal or alloy, with the electrically isolated electroplating processes using the same base metal or alloy providing the different appearance.

In one aspect, the first decorative metal layer 124 and the second decorative metal layer 132 have different gloss levels having different distinction of image (DOI).

In one aspect, the different gloss level and DOI is defined by an increased number of pits in a surface of the second decorative metal layer 132 relative to the first decorative metal layer 124, wherein the pits disturb the surface and cause reflected light to diffuse more than the first decorative metal layer 124, and the increased number of pits in the second decorative metal layer 132 results from electroplating.

In one aspect, the first decorative metal layer 124 and the second decorative metal layer 132 have different gloss levels and/or colors defined by electrically isolated electroplating such that the first segment 124 has a different appearance than the second segment 132 resulting from the electrically isolated electroplating and not from post-electroplating mechanical alteration. For example, the different surface finish or gloss level is provided by the electroplating and not from brushing, scratching, sanding, roughening, painting, etc. These different appearances resulting from the electroplating are distinguishable from such mechanically formed appearance alterations. That said, such mechanical alterations could be performed later on the above resulting electroplated product having the different surface finish appearances.

In one aspect, the first decorative metal layer 124 wraps around the base substrate 110 and continuously follows a contour thereof along both the front surface 140 and the back surface 142 of the base substrate 110 and over the first plateable base layer 108. In one aspect, the second decorative metal layer 132 wraps around the base substrate 110 and continuously follows a contour thereof along both the front surface 140 and the back surface 142 of the base substrate 110 and over the second plateable base layer 108.

The above described product 100 with the unique different surface finishes resulting from the electroplating is shown schematically at least in FIGS. 2-4 and 9-10, where one segment of the part on one side of the barrier has one of the surfaces finishes 124 and the other segment of the part on the other side of the barrier has the other surface finish 132. For example, in FIGS. 8 and 9, at the right side of the Figures, the surface finish at 132 has a different appearance than at 124.

It will be appreciated that the above described integrally molded component could have a barrier formed and/or applied to the component and present between the different discontinuous surface finishes. Put another way, the barrier does not have to be an integrally molded barrier. Instead, the plateable base layer 108 could be removed to define the barrier, or a plating resistant coating could be applied along the barrier prior to applying the plateable base layer 108. In one aspect, the barrier present along one portion of the part 100 could be of one type, with the rest of the barrier defined by another type, so long as the two plateable and plated segments 124, 132 with the different surface finishes are electrically isolated and discontinuous.

In one aspect, the first decorative layer 124 is a bright chrome and the second decorative layer 132 is a satin chrome, the bright chrome and satin chrome have different gloss levels and different distinction of image, wherein the satin chrome includes an increased number of pits in its surface relative to the bright chrome, thereby varying reflectivity of the second layer relative to the first layer. This structure is the result of the electroplating process, not from other types of alterations, such as brushing or abrading, and is apparent upon close inspection.

In one aspect, the molded component 100 is fully plated except for along the barrier 114, 214, 314, 514 to electrical conductivity. It will be appreciated that the schematic illustrations of FIGS. 2-4 and illustrates such a component 100 in a partial view, which is also illustrated in FIGS. 9-10, with the non-plated barrier portion 114, 214, 314, 514 separating the two segments 124, 132 on opposite sides of the barrier 114, 214, 314, 514.

Obviously, many modifications and variations of the present disclosure are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. A decorative automotive trim component, comprising:
a molded component having a molded base substrate with a first barrier to electrical conductivity disposed therealong, wherein the molded component has a front surface and a back surface opposing the front surface,
the base substrate being formed of a plastic metal plateable material, wherein the base substrate and the first barrier to electrical conductivity combine to define the overall shape of the molded component, upon which multiple stacked layers are applied to different segments, wherein the multiple stacked layers define different surface finishes on the different segments, wherein the multiple stacked layers conform to the shape of the molded component;
wherein the first barrier to electrical conductivity is disposed along the front surface of the base substrate, the first barrier to electrical conductivity dividing at least the front surface of the base substrate portion into a first segment and a second segment; whereby a continuous surface of the first segment is discontinuous relative to a continuous surface of the second segment;
a base layer of electroless plated metal material disposed on and covering the continuous surfaces of both the first segment and the second segment rendering them electrically conductive and electrically isolated from each other and defining a plateable first base layer segment of electroless plated material and a plateable second base layer segment of electroless plated material separated by the first barrier, wherein the non-plateable material of the first barrier is unplated by the electroless plated metal material and non-conductive and is disposed between the first base layer segment and the second base layer segment, and
wherein said first barrier to electrical conductivity does not have said base layer thereon, such that the first base layer segment of electroless plated material covering the first segment is discontinuous and electrically isolated relative to the second base layer segment of electroless plated material covering the second base layer segment;
a first decorative metal layer disposed on the first segment over the plateable first base layer segment, the first decorative metal layer adjacent to the first barrier;
a second decorative metal layer disposed on the second segment over the plateable second base layer segment disposed thereon, the second decorative metal layer adjacent to the first barrier;
wherein the first decorative metal layer and the second decorative metal layer have different surface finish appearances as a direct result of being electroplated via electroplating onto the plateable first base layer segment and the plateable second base layer segment and wherein the first barrier is disposed between the first and second decorative metal layers and completely electrically isolates the first decorative metal layer from the second decorative metal layer.

2. The decorative automotive trim component of claim 1, wherein the first decorative metal layer and the second decorative metal layer have different gloss levels having different distinction of image (DOI).

3. The decorative automotive trim component of claim 2, wherein the different gloss level and DOI is defined by an increased number of pits in a surface of the second decorative metal layer relative to the first decorative metal layer, wherein the pits disturb the surface and cause reflected light to diffuse more than the first decorative metal layer, and the increased number of pits in the second decorative metal layer results from electroplating.

4. The decorative automotive trim component of claim 1, wherein the first barrier is defined by an absence of the base layer.

5. The decorative automotive trim component of claim 1, wherein the first barrier is defined by an integrally molded non-conductive material.

6. The decorative component of claim 1, wherein the first decorative metal layer and the second decorative metal layer have different surfaces finishes resulting from electroplating and without post electroplating mechanical alteration.

7. The decorative automotive trim component of claim 1, wherein the first decorative metal layer and the second decorative metal layer have different surfaces defined by the same base metal resulting from different currents applied during electroplating.

8. The decorative automotive trim component of claim 1, wherein the first decorative layer is a bright chrome and the second decorative layer is a satin chrome, the bright chrome and satin chrome have different gloss levels and different distinction of image, wherein the satin chrome includes an increased number of pits in its surface relative to the bright chrome, thereby varying reflectivity thereof.

9. The decorative automotive trim component of claim 1, further comprising:
a plurality of barriers to electrical conductivity formed by an absence of said base layer of electroless plated metal material on the front surface of the base substrate portion to form multiple electrically isolated segments.

10. The decorative automotive trim component of claim 1, wherein the absence of the base layer is defined by laser ablation.

11. The decorative automotive trim component of claim 1, further comprising:
an intermediate layer disposed either on the first segment and beneath the first decorative metal layer or on the second segment and beneath the second decorative metal layer.

12. The decorative automotive trim component of claim 11, wherein the intermediate layer is formed from an acid copper material.

13. The decorative automotive trim component of claim 1, wherein the first decorative layer is selected from at least one of the following: copper, nickel, zinc, palladium, gold, cobalt, chromium, or alloys thereof.

14. The decorative automotive trim component of claim 1, wherein one of the first decorative layer or the second decorative layer is formed of an electrophoretic coating.

15. The decorative automotive trim component of claim 1,
wherein the first decorative metal layer wraps around the base substrate and continuously follows a contour thereof along both the front surface and the back surface of the base substrate and over the first plateable base layer;
wherein the second decorative metal layer wraps around the base substrate and continuously follows a contour thereof along both the front surface and the back surface of the base substrate and over the second plateable base layer.

16. The decorative automotive trim component of claim 1, wherein the decorative automotive trim component is fully plated except for along the barrier to electrical conductivity.

17. The decorative automotive trim component of claim 1, wherein the non-plateable material is a plating resistant coating applied directly on to the front surface.

18. A decorative automotive trim component, comprising:
an integrally molded component having a molded base substrate integrally molded with a molded first barrier to electrical conductivity, wherein the integrally molded component has
a front surface and a back surface opposing the front surface,
the base substrate being formed of a plastic metal plateable material, wherein the base substrate and the first barrier to electrical conductivity combine to define a single molded unitary structure defining the overall shape of the integrally molded component, upon which multiple stacked layers are applied to different segments, wherein the multiple stacked layers define different surface finishes on the different segments, wherein the multiple stacked layers conform to the shape of the integrally molded component;
wherein the first barrier to electrical conductivity is in the form of a non-plateable material molded into or onto at least the front surface of the base substrate portion, the first barrier to electrical conductivity dividing at least the front surface of the base substrate portion into a first segment and a second segment; whereby a continuous surface of the first segment is discontinuous relative to a continuous surface of the second segment;
a base layer of electroless plated metal material disposed on and covering the continuous surfaces of both the first segment and the second segment rendering them electrically conductive and electrically isolated from each other and defining a plateable first base layer segment of electroless plated material and a plateable second base layer segment of electroless plated material separated by the first barrier, wherein the non-plateable material of the first barrier is unplated by the electroless plated metal material and non-conductive and is disposed between the first base layer segment and the second base layer segment, and
wherein said first molded barrier to electrical conductivity does not have said base layer thereon, such that the first base layer segment of electroless plated material covering the first segment is discontinuous and electrically isolated relative to the second base layer segment of electroless plated material covering the second base layer segment;
a first decorative metal layer disposed on the first segment over the plateable first base layer segment, the first decorative metal layer adjacent to the first barrier;
a second decorative metal layer disposed on the second segment over the plateable second base layer segment disposed thereon, the second decorative metal layer adjacent to the first barrier;
wherein the first decorative metal layer and the second decorative metal layer have properties resulting from being formed of the same metal material or alloys thereof, being electroplated via electroplating onto the plateable first base layer segment and the plateable second base layer segment and wherein the first barrier is disposed between the first and second decorative metal layers and completely electrically isolates the first decorative metal layer from the second decorative metal layer,
wherein the first decorative metal layer and the second decorative metal layer have different gloss levels and/or colors defined by electrically isolated electroplating such that the first segment has a different appearance than the second segment resulting from the electrically isolated electroplating and not from post-electroplating mechanical alteration;
wherein the first decorative metal layer wraps around the base substrate and continuously follows a contour thereof along both the front surface and the back surface of the base substrate and over the first plateable base layer;
wherein the second decorative metal layer wraps around the base substrate and continuously follows a contour thereof along both the front surface and the back surface of the base substrate and over the second plateable base layer.

19. The decorative automotive trim component of claim 18, wherein the first barrier is a molded barrier integrally molded with the base substrate.

20. The decorative automotive trim component of claim 19, further comprising:
a second barrier to electrical conductivity formed on the back surface of the base substrate portion, wherein the second barrier to electrical conductivity does not have the base layer thereon, wherein the first barrier and the second barrier to electrical conductivity combine to define a closed loop.

21. The decorative automotive trim component of claim 19, wherein said first barrier to electrical conductivity further comprises a colored material to provide a different visual effect.

22. The decorative automotive trim component of claim 19, wherein said first barrier to electrical conductivity further comprises a translucent or transparent material to allow for the passage of light therethrough.

23. The decorative automotive trim component of claim 19, wherein the integrally molded component is fully plated except for along the barrier to electrical conductivity.

24. A decorative automotive trim component, comprising:
a one-piece, non-assembled molded component having a molded base substrate with a first barrier to electrical conductivity disposed therealong, wherein the molded component has a front surface and a back surface opposing the front surface,
the base substrate being formed of a plastic metal plateable material, wherein the base substrate and the first barrier to electrical conductivity combine to define the overall shape of the molded component, upon which multiple stacked layers are applied to different segments, wherein the multiple stacked layers define different surface finishes on the different segments, wherein the multiple stacked layers conform to the shape of the molded component;
wherein the first barrier to electrical conductivity is a non-plateable material disposed on the front surface of the base substrate portion, the first barrier to electrical conductivity dividing at least the front surface of the base substrate portion into a first segment and a second segment;
whereby a continuous surface of the first segment is discontinuous relative to a continuous surface of the second segment;
a base layer of electroless plated metal material disposed on and covering the continuous surfaces of both the first segment and the second segment rendering them electrically conductive and electrically isolated from each other and defining a plateable first base layer segment of electroless plated material and a plateable second base layer segment of electroless plated material separated by the first barrier, wherein the non-plateable material of the first barrier is unplated by the electroless plated metal material and non-conductive and is disposed between the first base layer segment and the second base layer segment, and
wherein said first barrier to electrical conductivity does not have said base layer thereon, such that the first base layer segment of electroless plated material covering the first segment is discontinuous and electrically isolated relative to the second base layer segment of electroless plated material covering the second base layer segment;
a first decorative metal layer disposed on the first segment over the plateable first base layer segment, the first decorative metal layer adjacent to the first barrier;
a second decorative metal layer disposed on the second segment over the plateable second base layer segment disposed thereon, the second decorative metal layer adjacent to the first barrier;
wherein the first decorative metal layer and the second decorative metal layer have properties resulting from being formed of the same metal material or alloys thereof, being electroplated via electroplating onto the plateable first base layer segment and the plateable second base layer segment and wherein the first barrier is disposed between the first and second decorative metal layers and completely electrically isolates the first decorative metal layer from the second decorative metal layer,
wherein the first decorative metal layer and the second decorative metal layer have different gloss levels defined by electrically isolated electroplating such that the first segment has a different appearance than the second segment resulting from the electrically isolated electroplating and not from post-electroplating mechanical alteration.
